(19) United States
(12) Patent Application Publication
(10) Pub. No.: US 2006/0013121 A1
(43) Pub. Date: Jan. 19, 2006

(54) Method and apparatus for adding auxiliary channels in an existing transmission system

(76) Inventor: Hong Jiang, Warren, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(21) Appl. No.: 10/892,841

(22) Filed: Jul. 16, 2004

(51) Int. Cl. H04J 11/00

(52) U.S. Cl. 370/207

(57) ABSTRACT

A unique new modulation scheme is employed to add the auxiliary channel. This is realized, in one embodiment of the invention, in a quadrature phase shift keying (QPSK) transmission system, by utilizing a “large” phase variation component to modulate the primary channel and a relatively “small” amplitude variation component to modulate the new auxiliary channel. There are a number of known transmission schemes in which applicant's unique auxiliary channel modulation scheme can be used to realize his unique invention. One example for such a transmission system an enhanced QPSK transmission system. The primary channel, or the original transmission system, uses PQSK where every two bits of data is mapped to a symbol I+j Q, where j is the imaginary unity. In the enhanced QPSK transmission system, every two bits from the primary channel data, and every two bits from the auxiliary channel data are mapped to the symbol I(1+/−a)+j Q(1+/−a). The mapping between the two bits from the primary channel data and I, Q is the same as in the prior QPSK system. However, in the enhanced QPSK system, the auxiliary channel data is carried in the system by the variation +/−a. The sign “+/−” depends on the polarity of the auxiliary channel bits. The amplitude “a” can be adjusted to adjust the data rate of the auxiliary channel and the interference to the primary channel.

### RELATED APPLICATION

U.S. patent application Ser. No. (H. Jiang 16) was filed concurrently herewith.

### TECHNICAL FIELD

This invention relates to communication systems and, more particularly, to transmitting auxiliary channels in an existing system.

### BACKGROUND OF THE INVENTION

Many known digital transmission systems, especially those that utilize satellites, employ quadrature phase shift keying (QPSK) as the modulation format for transmitting digital data. Examples of such systems are digital satellite television, digital satellite radio and the like. Such digital transmission systems usually include a variety of transmission equipment, for example, a data source generator, a source encoder, a channel encoder and a modulator. The modulator, in well known fashion, modulates the encoded source data in a particular format, in this example QPSK, for transmission over a transmission medium to remote receivers. Typically, at the receivers an antenna receives the modulated data signal, a demodulator demodulates the signal, which is then decoded by an appropriate decoder. The modulator and demodulator employed in such systems are designed for a particular system to operate in conjunction in a specific format.

When such a system is deployed, usually a significantly large number of receivers are used by so-called end users in order to receive services provided by the particular transmission system. Examples of these receivers are digital satellite television (TV) receivers, digital radio receivers or the like. Often after such systems have been in service, it is desirable to be able to enhance the services that are being provided to the end users. To achieve this enhancement usually requires that additional data must be transmitted in the existing system.

A possible solution to the problem of adding the additional data is to use a so-called auxiliary data channel. However, there are difficulties in adding such an auxiliary channel. One difficulty in adding an auxiliary channel is the fact that the existing system, i.e., the primary system, is designed to transmit a specific data rate, and the addition of the auxiliary channel would require a reduction in this primary data rate, which is undesirable. Another problem is that the new system must or should be backward compatible with existing receivers so that the existing receivers can at least receive the primary channel data. Otherwise, the cost of replacing all the existing receivers in the system could be prohibitive.

### SUMMARY OF THE INVENTION

These and other problems and limitations of the prior known transmission systems are overcome by employing a unique new modulation scheme to add the auxiliary channel.

This is realized, in one embodiment of the invention, for example, in a quadrature phase shift keying (QPSK) transmission system, by utilizing a “large” phase variation component to modulate the primary channel and a relatively “small” amplitude variation component to modulate the new auxiliary channel.

There are a number of known transmission schemes in which applicant's unique auxiliary channel modulation scheme can be used to realize his unique invention. One example for such a transmission system an enhanced QPSK transmission system. The primary channel, or the original transmission system, uses PQSK where every two bits of data is mapped to a symbol I+j Q, where j is the imaginary quantity. In the enhanced QPSK transmission system, every two bits from the primary channel data, and every two bits from the auxiliary channel data are mapped to the symbol I(1+/−a)+j Q(1+/−a). The mapping between the two bits from the primary channel data and I, Q is the same as in the prior QPSK system. However, in the enhanced QPSK system, the auxiliary channel data is carried in the system by the variation +/−a. The sign “+/−” depends on the polarity of the auxiliary channel bits. The amplitude “a” can be adjusted to adjust the data rate of the auxiliary channel and the interference to the primary channel.

In a receiver that is deployed before the enhanced QPSK system is introduced, the amplitude variation +/−a represents a small noise in the transmission system. Such a receiver will demodulate the primary channel only, regarding I(1+/−a)+j Q(1+/−a) as simply I+j Q. New receivers can be built to receive both the primary and the auxiliary channel data. Such new receivers will extract both I, Q for the primary channel, and +/−a for the auxiliary channel.

### BRIEF DESCRIPTION OF THE DRAWING

FIG. 1 shows, in simplified block diagram form, details of a prior known QPSK modulator;

FIG. 2 graphically illustrates a constellation generated by the prior known QPSK modulator shown in FIG. 1;

FIG. 3 shows, in simplified block diagram form, details of an enhanced QPSK modulator in accordance with the invention;

FIG. 4 graphically illustrates a constellation generated by an embodiment of the enhanced QPSK modulator shown in FIG. 3;

FIG. 5 depicts, in simplified block diagram form, an enhanced QPSK transmission system embodying an embodiment of the invention; and

FIG. 6 shows, in simplified block diagram form, details of an enhanced QPSK receiver used in the system of FIG. 5.

### DETAILED DESCRIPTION

FIG. 1 shows, in simplified block diagram form, details of a prior known QPSK modulator 100. Specifically, shown are bits to QPSK Mapping Unit 101 and Modulation Unit 102.

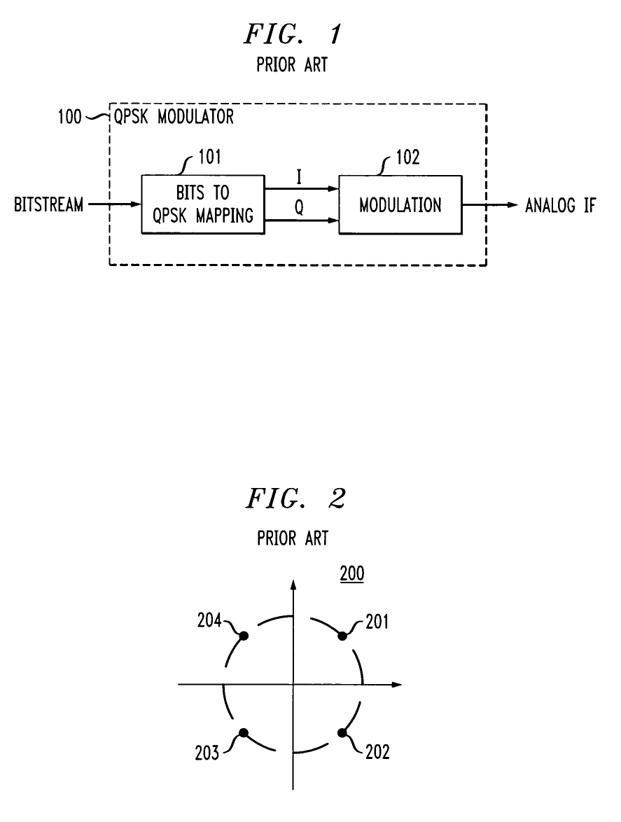

In QPSK modulation, a cosine carrier is typically varied in phase while maintaining a constant amplitude and frequency. The term “quadrature” implies that there are four possible phases (4-PSK), which the carrier can have at a given time, as shown in FIG. 2 on the characteristic constellation. The four phases are labeled 201, 204, 203 and 202 corresponding to one of 45, 135, 225 and 315 degrees, respectively.

In QPSK, information is conveyed through phase variations. This is realized in Bits to QPSK Mapping Unit 101 where the input digital bitstream is mapped into the in-phase (I) and quadrature-phase (Q) components of the QPSK signal (the primary QPSK channel). The I component is the real part and the Q component is the imaginary part of the QPSK symbols. Specifically, in each time period, the phase can change once. Since there are four possible phases, there are 2 bits of information conveyed within each time slot. That is, a pair of input data bits is mapped via Bits to QPSK Mapping Unit 101 into the I and Q components. The rate of change (baud) in this signal determines the signal bandwidth, but the throughput or bit rate for QPSK is twice the baud rate.

The I and Q components are supplied to Modulation Unit 102 where they are modulated into a particular scheme for transmission. The modulator typically takes the I and Q components, performs a pulse shaping filtering on the I and Q component signals, and then converts the resulting digital signals to either an analog intermediate frequency (IF) signal, or an analog baseband signal.

FIG. 3 shows, in simplified block diagram form, details of an Enhanced QPSK Modulator 300, in accordance with the invention. Specifically, shown are Bits to QPSK Mapping Unit 301, Modify QPSK Constellation Unit 302 and Modulation Unit 303. Here, the primary channel input bit stream is supplied to Bits to Mapping Unit 301, which operates in identical fashion as Bits to QPSK Mapping Unit 101 of FIG. 1 to generate the primary channel I and Q components. These primary channel I and Q components are supplied to Modify QPSK Constellation Unit 302 along with the auxiliary channel input bits.

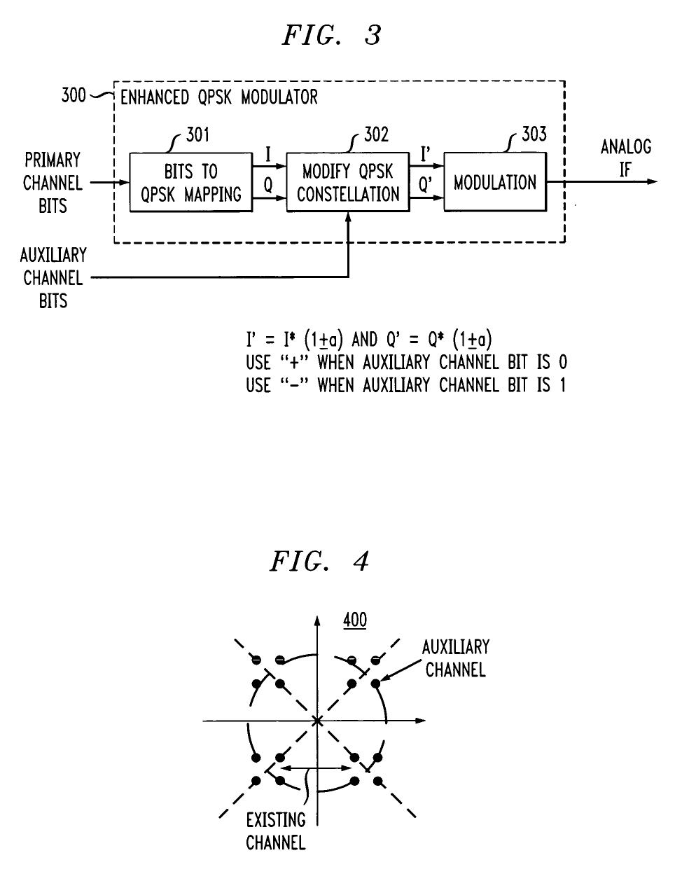

Operation of Modify QPSK Constellation Unit 302 is to generate the enhanced QPSK constellation, an example of which is shown as constellation 400 of FIG. 4. This is realized, in accordance with the invention, by Modify QPSK Constellation Unit 302 generating the enhanced QPSK symbols including components I′ and Q′.

As indicated above, the primary channel, or the original transmission system, uses PQSK where every two bits of data is mapped to a symbol I+j Q, where j is the imaginary unity. In the enhanced QPSK transmission system, every two bits from the primary channel data, and every two bits from the auxiliary channel data are mapped to the symbol I(1+/−a)+j Q (1+/−a). The mapping between the two bits from the primary channel data and I, Q is the same as in the prior QPSK system. However, in the enhanced QPSK system, the auxiliary channel data is carried in the system by the variation +/−a. The sign “+/−” depends on the polarity of the auxiliary channel bits. The amplitude “a” can be adjusted to adjust the data rate of the auxiliary channel and the interference to the primary channel.

In a receiver that is deployed before the enhanced QPSK system is introduced, the amplitude variation +/−a represents a small noise in the transmission system. Such a receiver will demodulate the primary channel only, regarding I(1+/−a)+j Q(1+/−a) as simply I+j Q. New receivers can be built to receive both the primary and the auxiliary channel data. Such new receivers will extract both I, Q for the primary channel, and +/−a for the auxiliary channel.

In one specific embodiment, I′ and Q′ are generated for each primary channel symbol (I, Q) by taking two (2) auxiliary channel input bits, for example, b1 and b2, to form in conjunction with the I and Q components from the primary channel the enchanted QPSK symbol components I′ and Q′ as follows:
If b1=0, then I′=I(1+a), and if b1=1, then I′=I(1−a);
If b2=0, then Q′=Q(1+a), and if b2=1, then Q′=Q(1−a),
where b1 and b2 are logical 1 or logical 0.

It is noted that this is but one example of an embodiment of the invention. It is further noted the parameter “a” is typically less than one (1), and in one specific example “a” is 0.1. There are a number of arrangements in which the auxiliary channel can be modulated by +/−a. One example of such a system, is the Direct Sequence Spread Spectrum Code Division Multiplex Access (DS-CDMA) system. In such a system, the value of parameter “a” can be adjusted to control the data rate of the auxiliary channel. In general, the larger the value of parameter “a” is, the higher the data rate of the auxiliary channel.

Thus, as indicated above, the primary channel QPSK components I and Q are obtained by utilizing a “large” phase variation component to modulate the primary channel and, then, the enhanced QPSK components I′ and Q′ are realized by utilizing a relatively “small” amplitude variation component to modify the QPSK components I and Q in Modify QPSK Constellation Unit 302 to obtain the new auxiliary channel in the enhanced QPSK channel including components I′ and Q′. By way of an example, if the phase variation is such that the primary channel vector amplitude is “1”, then the magnitude of parameter “a” initially is approximately “0.1”. Modulation Unit 303, operates in identical fashion as Modulation Unit 102 of FIG. 1, to convert the digital signals to either an analog IF output signal, or analog baseband output signal.

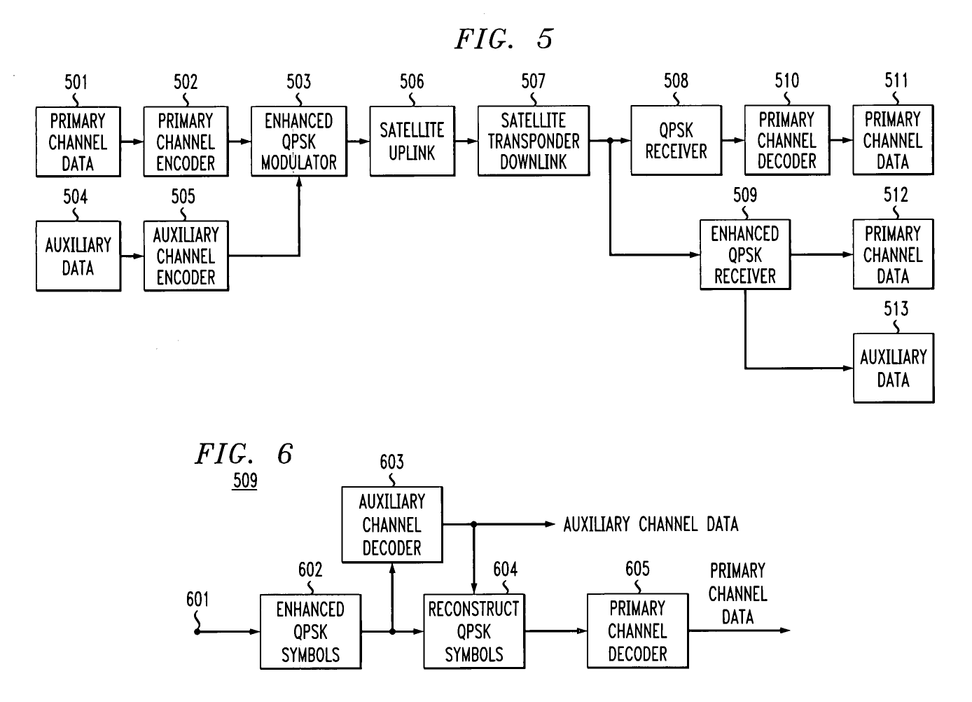

In the enhanced QPSK modulation scheme of FIG. 3, the auxiliary channel acts as relative small white noise components to the primary channel. Consequently, it is possible to continue using existing receivers to receive at least the primary channel in the enhanced QPSK system without need for any modification. However, the auxiliary channel, acting as white noise, does impose a small penalty in the performance of the existing receivers. This penalty depends of the value of parameter “a”. The larger parameter “a” is, the larger the penalty is. However, a new enhanced QPSK receiver 509 of FIG. 5 and shown in FIG. 6, to be described below, for the enhanced QPSK system, is readily designed to avoid any such penalty. That is, the new enhanced QPSK receiver 509 is designed such that its performance in receiving the primary channel is as good as the receivers in the prior QPSK system before the auxiliary channel was added.

It is estimated that by employing, for example, the DS-CDMA scheme for the auxiliary channel, parameter “a” is approximately 10% of the amplitude of the primary channel symbols, then the penalty to the prior existing receivers is approximately 0.2 dB under most operating conditions, while the data rate of the auxiliary channel is approximately 1% of that of the primary channel, with the same error rate as the primary channel.

Again, parameter “a” is a system parameter that controls the amount of penalty to the prior existing QPSK receivers, and the data rate of the auxiliary channel in the enhanced QPSK system. Thus, initially the value of parameter “a” for the enhanced QPSK system can be chosen to be relatively small, for example, the 0.1 value noted above, so that only a relatively small penalty results in the prior existing receivers. As these prior existing QPSK receivers are gradually phased out of service, the value of parameter “a” can be increased to increase the bit rate of the auxiliary channel.

FIG. 4 graphically illustrates a constellation generated by an embodiment of the enhanced QPSK modulator shown in FIG. 3. As shown, the auxiliary channel modulation results in the constellation points about the primary channel modulation at each of the vectors at 45, 135, 225 and 315 degrees. When the auxiliary channel is added, there are the following possibilities:
Using the first quadrant as an example: the symbol is I+j Q, where I=1, Q=1.
The conventional QPSK is one point at (1,1) in the first quadrant.

Then the for the enhanced symbol:
I′ the real part is: 1+a, 1−a, and Q′ the imaginary part is: 1+a, 1−a, depending on the polarity of the auxiliary channel bits b1 and b2, as indicated above. This creates four possible positions at each vector:
   (1+a,1+a), (1+a,1−a), (1−a,1+a) and (1−a, 1−a).

These are the four points on the first quadrant vector of the constellation of FIG. 4. It will be apparent that for the vectors in the other quadrants that I=−1, Q=1; I=−1, Q=−1; and I=1, Q=−1.

FIG. 5 depicts, in simplified block diagram form, an enhanced QPSK transmission system embodying an embodiment of the invention. Specifically shown is primary channel data source 501 that supplies, digital or otherwise, to primary channel encoder 502. Primary channel encoder 502 encodes the incoming primary channel data into a particular format as desired. In one example, the primary channel format is convolutional encoding. Thereafter, the encoded primary bit stream is supplied as an input to enhanced QPSK modulator 503. Similarly, incoming auxiliary channel data is supplied from auxiliary data source 504 to auxiliary channel encoder 505. Auxiliary channel encoder 505 encodes the incoming auxiliary channel data into a particular format as desired. In one example, the auxiliary channel format is Direct Sequence Spread Spectrum Code Division Multiplex Access (DS-CDMA). Thereafter, the encoded primary bit stream is supplied as a second input to enhanced QPSK modulator 503. As described above, enhanced QPSK modulator 503 generates a modulated output signal, for example, an analog intermediate frequency signal, which is supplied, in this example, to satellite uplink unit 506. Satellite uplink unit 506, in response to the supplied IF signal, typically generates a high frequency transmission signal, in known fashion, to carry the enhanced QPSK modulated data to a remote location, in this example, a satellite. In the satellite, the transmission signal is received and supplied to a satellite transponder where it is prepared for transmission to one or more earth stations, again in well known fashion. The earth stations could be either fixed or mobile. At an earth station there could be a prior existing QPSK receiver 508 or a new enchanted QPSK receiver 509. Details of new enchanted QPSK receiver 509 are shown in FIG. 6 and described below. QPSK receiver 508 demodulates the incoming signal and supplies the demodulated bit stream to primary channel decoder 510. The demodulation in QPSK receiver 508 is the inverse of the primary channel modulation effected in enhanced QPSK modulator 503 on the transmitter side. Similarly, primary channel decoder 510 effects the decoding of the bit stream in accordance with the inverse of the encoding format used in the primary channel encoder 502. The decoded data signal is supplied to the prior known primary channel data unit 511. Also on the receive side, new enhanced QPSK receivers 509 are also deployed. Enhanced QPSK receiver 509 effect the demodulation of both the primary channel modulated signal and the auxiliary channel modulated signal. The demodulated primary channel data is supplied to primary channel data unit 512, while the demodulated auxiliary channel data is supplied to auxiliary data unit 513. The primary channel and auxiliary channel data units output the primary and auxiliary data in desired form as desired by a user of the enhanced QPSK receiver.

FIG. 6 shows, in simplified block diagram form, details of enhanced QPSK receiver 509. The received incoming signals are supplied from input terminal 601 to received enhanced symbols unit 602, which extracts the enhanced symbols from the incoming signal, in known fashion. This process usually involves a digital filter, timing recovery, carrier recovery and equalization. The recovered enhanced QPSK symbols are used in auxiliary channel decoding unit 603, which extracts the auxiliary channel data. In unit 603, the amplitude variation +/−a of the enhanced QPSK symbols I (1+/−a)+j Q (1+/−a) is detected in conjunction with the channel encoding, such as DS-CDMA. The detected amplitude variation +/−a is used to decode the auxiliary channel data.

The primary channel data can be extracted, i.e., reconstructed, from the enhanced QPSK symbols by ignoring the amplitude variation +/−a. The existing receivers that are deployed before the enhanced QPSK system is introduced can receive the primary channel data in this fashion. However, in new receivers, the reception performance of the primary channel can be improved by the reconstruct QPSK symbols unit 604. Since the amplitude variation, +/−a, is detected in unit 603, it can be subtracted from the enhanced QPSK symbols I(1+/−a)+j Q(1+/−a) to reconstruct the QPSK symbols I+j Q. The reconstructed QPSK symbols are used in the primary channel decoding unit 605 where the QPSK symbols are decoded into the primary channel using a QPSK decoder in a well known standard fashion.

Although this embodiment of the invention has been described in terms of QPSK, it will apparent to those skilled in the art that it is equally applicable to other modulation schemes. Examples of such modulation schemes are quadrature amplitude modulation (QAM), 16 phase shift keying (16 PSK) and the like.

What is claimed is:

1. Apparatus for use in adding an auxiliary channel in a communications transmission system comprising:
a mapper for mapping primary channel data bits into first symbols in a constellation of a predetermined first modulation scheme; and
a modification unit supplied with said primary channel symbols and auxiliary channel data bits for modifying said first symbols in said constellation in accordance with a predetermined second modulation scheme to generate enhanced symbols in said constellation,
wherein both said primary channel data and said auxiliary channel data are included in said enhanced symbols in said constellation.

2. The apparatus as defined in claim 1 wherein said mapper maps every two bits of said primary channel data into symbols of the type I+jQ, where I is magnitude of the real part, Q is the magnitude of the imaginary part and j represents the imaginary quantity.

3. The apparatus as defined in claim 2 wherein said modification unit generates said enhanced symbols in response to said I and Q values from said mapper and in accordance with the logical state of said auxiliary channel data bits.

4. The apparatus as defined in claim 3 wherein said enhanced symbols are generated in accordance with I′=I(1+a) and Q′=Q(1+a) when said auxiliary channel data bit is a first logical value, and I′=(1−a) and Q′(1−a) when said auxiliary channel data bit is a second logical value, where I′ is the real part and Q′ is the imaginary part of the enhanced symbol, and “a” is a parameter representing the magnitude of the modulation due to the auxiliary channel data bits.

5. The apparatus as defined in claim 4 wherein said parameter “a” is adjustable.

6. The apparatus as defined in claim 4 wherein said parameter “a” is a predetermined percentage of the magnitude of the primary channel symbol magnitude.

7. The apparatus as defined in claim 6 wherein said percentage is approximately 10 percent.

8. The apparatus as defined in claim 1 where said first modulation scheme is quadrature frequency shift keying (QPSK).

9. The apparatus as defined in claim 1 where said second modulation scheme is amplitude modulation.

10. The apparatus as defined in claim 1 further including a first encoder for encoding said primary channel data bits and a second encoder for encoding said auxiliary channel data bits.

11. The apparatus as defined in claim 10 wherein said first encoder is a convolution encoder and said second encoder is a Direct Sequence Spread Spectrum Code Division Multiplex Access (DS-CDMA) encoder.

12. A method for use in adding an auxiliary channel in a communications transmission system comprising the steps of:
mapping primary channel data bits into first symbols in a constellation of a predetermined first modulation scheme; and
in response to said primary channel symbols and auxiliary channel data bits, modifying said first symbols in said constellation in accordance with a predetermined second modulation scheme to generate enhanced symbols in said constellation,
wherein both said primary channel data and said auxiliary channel data are included in said enhanced symbols in said constellation.

13. The method as defined in claim 12 wherein said mapping step maps every two bits of said primary channel data into symbols of the type I+jQ, where I is magnitude of the real part, Q is the magnitude of the imaginary part and j represents the imaginary quantity.

14. The method as defined in claim 13 wherein said modifying step includes a step of generating said enhanced symbols in response to said I and Q values and in accordance with the logical state of said auxiliary channel data bits.

15. The method as defined in claim 12 wherein said first modulation scheme is quadrature phase shift keying (QPSK).

16. The method as defined in claim 12 wherein said second modulation scheme is amplitude modulation.

17. Apparatus for use in receiving an auxiliary channel in a communications system comprising:
a receiver for receiving a communications signal including enhanced symbols, said enhanced symbols including primary channel symbols modified by modulation by an auxiliary channel parameter dependent on the logical states of auxiliary channel data bits; and
a recovery unit for obtaining auxiliary channel data bits from said received enhanced symbols.

18. The apparatus as defined in claim 17 further including a reconstruction unit supplied with said received enhanced symbols for reconstructing primary channel symbols from said received enhanced symbols and for generating primary channel data bits from said primary channel symbols.

19. A method for use in receiving an auxiliary channel in a communications system comprising the steps of:
receiving a communications signal including enhanced symbols, said enhanced symbols including primary channel symbols modified by modulation by an auxiliary channel parameter dependent on the logical states of auxiliary channel data bits; and
utilizing said received enhanced symbols to obtain auxiliary channel data bits.

20. The method as defined in claim 19 further including steps of reconstructing primary channel symbols from said received enhanced symbols and for generating primary channel data bits from said primary channel symbols.
